(19) United States
(12) Patent Application Publication
(10) Pub. No.: US 2026/0278057 A1
(43) Pub. Date: Sep. 17, 2026

(54) ENTERPRISE-SCALE CONTINUOUS BIOMETRIC AUTHENTICATION WITH ADAPTIVE TRIGGER MODULATION, MULTI-PARTY LOGIC, VIDEO PROXYING, DYNAMIC HELPDESK VERIFICATION, DUAL-DOMAIN PRESENCE CORROBORATION, AND UNIFIED SOVEREIGN IDENTITY ARCHITECTURE

(71) Applicant: SPIALERT LLC, Holmdel, NJ (US)

(72) Inventor: Yevgeny Kushnir, Holmdel, NJ (US)

(21) Appl. No.: 19/633,650

(22) Filed: Mar. 30, 2026

Related U.S. Application Data
(63) Continuation-in-part of application No. 18/886,344, filed on Sep. 16, 2024.
(60) Provisional application No. 63/780,920, filed on Mar. 31, 2025.

(51) Int. Cl. G06F 21/32; G06F 21/53; G06F 21/55; H04L 9/08; H04L 9/32

(52) U.S. Cl. CPC G06F 21/32; G06F 21/53; G06F 21/55; H04L 9/0891; H04L 9/3213

(57) ABSTRACT

This disclosure is directed to methods for securing physical and remote computing sessions including receiving a state-change request associated with a Single Sign-On session, the request comprising a Session Origin Vector identifying a computing environment, intercepting the state-change request by suspending an execution thread of a host application prior to memory commitment, delivering an On-Demand Ephemeral Executable comprising a browser-executable sandbox module to a client interface, executing local flat object detection and biometric vector extraction at a network edge via the browser-executable sandbox module without transmitting raw video streams over a network, analyzing physiological telemetry via a deterministic neural network to detect capacity anomalies wherein the deterministic neural network operates without Large Language Models, generating a Capacity Token upon a successful physiological analysis and cryptographically binding the Capacity Token to the Session Origin Vector, and releasing the suspension of the execution thread upon confirmation of the bound Capacity Token.

### CROSS REFERENCE TO RELATED APPLICATIONS

This application is a continuation in part of U.S. application Ser. No. 18/886,344 filed on Sep. 16, 2024; and claims priority to U.S. Provisional Application No. 63/780,920 filed on Mar. 31, 2025; with both applications herein incorporated by reference in their entireties.

### BACKGROUND

### Technical Field of the Invention

The present disclosure generally relates to enterprise computing security, specifically the continuous authentication of users across managed endpoints, unmanaged (Bring Your Own Device—BYOD) environments, and Industrial Internet of Things (IIoT)/Operational Technology (OT) networks, physical access control infrastructure, and virtual desktop and enterprise browser environments. It relates to the dynamic tracking of biometric descriptors, agentless session enforcement via logic thread interception, and passive physiological capacity analysis, dual-domain physical-digital presence corroboration, and unified sovereign identity architecture spanning digital and physical security domains and the detection of physical environment anomalies including unauthorized observers, photography-capable devices directed at managed endpoint displays, and changes to the physical security environment in proximity to a managed computing device.

### Description of the Related Art

Enterprise authentication solutions often rely on single-instance validation, which fails to confirm that the correct user remains present throughout a session. Current systems suffer from a lack of transactional specificity; they cannot enforce topology-agnostic multi-party approvals (e.g., dual custody or N-of-M authorization) or detect procedural fraud and social engineering during remote collaboration interactions, such as helpdesk support, telehealth visits, or government service renewals. Furthermore, the threat landscape has evolved to include deepfake technology and hardware spoofing via USB injectors that masquerade as legitimate webcams. Traditional blocklists fail to detect these attacks because the hardware presents valid, signed descriptors to the operating system. Finally, continuous monitoring solutions often create hardware resource contention when running alongside third-party communication applications, or they consume excessive compute resources leading to device denial-of-service. Existing solutions do not correlate physical access control events with digital session state, creating a gap wherein a user who has physically departed a secured facility may maintain an active and undetected digital session. Additionally, existing solutions do not detect when unauthorized individuals in the physical proximity of a managed endpoint are observing the device display, using photography-capable devices to capture screen content, or otherwise creating physical security threats that are invisible to software-only authentication systems. Behavioral anomaly detection systems in the prior art measure deviation from organizational peer group norms rather than from an individual user's personal historical baseline, reducing detection accuracy for compromised accounts whose attacker behavior is statistically normal within the peer group. There remains a critical need for an architecture that orchestrates physiological capacity verification, deep hardware input consistency analysis, automated, adaptive system-level remediation at the specific moment of transaction execution, and cross-domain corroboration of physical presence and digital session state against a unified sovereign biometric identity database. Furthermore, existing solutions cannot verify the identity of an untrusted remote participant in a live collaboration session from the existing video stream without requiring that participant to have pre-enrolled a trusted device, installed specialized software, or taken any prior action, leaving video-based impersonation and synthetic media injection by remote participants undetectable during active sessions.

### SUMMARY DISCLOSURE OF THE INVENTION

The present invention is directed to methods and systems for securing physical and remote computing sessions and physical access control infrastructure via agentless continuous physiological capacity enforcement, and dual-domain presence corroboration anchored by a unified sovereign biometric identity architecture. In one aspect, the invention provides a method including receiving a state-change request associated with a Single Sign-On session, the request comprising a Session Origin Vector identifying a computing environment, intercepting the state-change request by one of suspending an execution thread of a host application prior to memory commitment, intercepting an application programming interfaces call, or interrupting a session state transition of the host application prior to committing the state change, delivering an On-Demand Ephemeral Executable comprising a browser-executable sandbox module to a client interface, executing local flat object detection and biometric vector extraction at a network edge via the browser-executable sandbox module without transmitting raw video streams over a network, analyzing physiological telemetry via a deterministic neural network to detect capacity anomalies wherein the deterministic neural network operates without Large Language Models, generating a Capacity Token upon a successful physiological analysis and cryptographically binding the Capacity Token to the Session Origin Vector, and releasing the intercepted state-change request upon confirmation of the bound Capacity Token.

The present invention provides a unified, sovereign architecture for continuous biometric authentication of physically present and remote users across multiple deployment domains. The sovereign central server, whose administrative access and biometric data governance are controlled by or exclusively on behalf of the enterprise client regardless of physical hosting location, serves as the authoritative identity resolution hub for managed endpoints, unmanaged BYOD devices, IoT and OT assets, physical access control infrastructure, enterprise browser environments, and thin client deployments. For unmanaged devices, the system utilizes an agentless architecture via an On-Demand Ephemeral Executable that performs passive physiological capacity analysis and calculates a Physics-Based Input Integrity Score to defeat hardware spoofing. The system employs Adaptive Trigger Modulation, dynamically censoring the complexity of security checks based on device health telemetry.

For managed devices, the system incorporates a Video Proxy Service that creates a virtual duplicate of the hardware video input to resolve resource contention during multi-streaming. The architecture further provides a Multi-Party Authorization Engine supporting sequential and simultaneous distributed approvals. To combat social engineering, the system introduces bifurcated Helpdesk Verification, capable of authenticating users dynamically via in-band collaboration video streams or via an on-demand device redirect workflow. Upon anomaly detection, the system executes an application-layer graphical obfuscation that safely suppresses hardware input events as a direct byproduct, expressly without modifying underlying hardware states. The system further provides a Dual-Domain Presence Corroboration Engine that cross-validates physical access control entry events against digital session establishment events for the same enrolled user identifier, detecting anomalous sessions that lack corroborating physical presence verification. The system maintains a multi-source enrollment pipeline supporting live first-login enrollment, out-of-band batch enrollment from authoritative external sources including human resources management systems, physical access control badging systems, and identity verification platforms, and continuous biometric template learning within verified sessions only. An Adaptive Environmental Descriptor Weighting Engine dynamically adjusts the relative authority of individual biometric descriptors based on current environmental conditions and assigns risk classifications to known, modified, and novel environments, driving configurable automated device response policies. The system further monitors the physical environment for unauthorized observers and photography-capable devices directed at the managed endpoint display, classifying such detections as environmental security events and applying configured risk policies including screen visibility manipulation and session management actions. The system further provides in-band collaboration verification capable of accessing the video stream of an untrusted remote participant through multiple architectures, including via an intermediary network gateway, within a corporate virtual asset hosting the collaboration session, or by replicating the incoming far-end video stream at a participating device, and performing biometric identity verification and synthetic media detection on the remote participant without requiring any prior enrollment or device modification on the remote participant's side.

Other features and aspects will be apparent from the following detailed description, the drawings, and the claims.

### DETAILED DISCLOSURE OF THE INVENTION

The following detailed description is provided to assist the reader in gaining a comprehensive understanding of the methods, products, and/or systems, described herein. However, various changes, modifications, and equivalents of the methods, products, and/or systems described herein will be apparent to an ordinary skilled artisan.

### MODES FOR CARRYING OUT THE INVENTION

### Sovereign Enterprise Centralization

The system is anchored by a central management server sovereign to the enterprise. As used herein, a central management server sovereign to the enterprise refers to a server whose administrative access, biometric data governance, and security policy authority are controlled by or exclusively on behalf of the enterprise client, regardless of the physical hosting location of the server, including on-premises deployment within the enterprise's own infrastructure and hosted deployment operated by a service provider under contractual data governance obligations to the enterprise. The sovereign server is deployable as a containerized application in a client-managed environment or as a hosted service and is horizontally scalable according to enterprise requirements. The system can operate without utilizing k-means clustering of organizational behavior and expressly without embedding authentication objects or verification tokens into standard network packet headers. The system governs outbound network connections exclusively at the application layer by binding connections to a session-specific cryptographic token managed within the application's execution context, expressly without modifying, tagging, or inspecting network packet headers, thereby functioning without requiring network infrastructure modifications or deep packet inspection capabilities. Furthermore, the system utilizes standard optical sensors and operates expressly without the use of coherent light sources or specialized retinal scanning sensors of the type used in iris recognition or ophthalmological imaging systems.

### Adaptive Environmental Descriptor Weighting Engine

The system employs an Adaptive Environmental Descriptor Weighting Engine to maximize biometric comparison accuracy across varying environmental conditions and to classify environments by risk level. The system agent deployed on a managed endpoint continuously collects environmental baseline data as conditions change. The primary baseline components include ambient lighting characteristics, known background objects within the camera field of view, and environmental factors that influence biometric descriptor reliability. The system dynamically adjusts the weighting of individual biometric descriptors in the authentication decision based on the current environmental state. For example, when ambient lighting degrades, the system increases the relative authority of geometric facial landmark descriptors and reduces reliance on descriptors sensitive to illumination variation. The system classifies each environment encountered into one of three categories: known, modified, or novel. A known environment matches the stored environmental baseline within configured tolerances. A modified environment shows significant deviation from the stored baseline. A novel environment has no corresponding baseline record. Modified and novel environments receive elevated risk classifications that increase authentication scrutiny thresholds and may trigger additional verification steps according to client-configurable policy mappings. Upon identification and verification in a novel environment, the system creates a new baseline record. The risk classification output of the Adaptive Environmental Descriptor Weighting Engine is a direct input to the system's composite risk score. The system automatically adjusts device response configurations, including authentication complexity requirements, session timeout parameters, and access privilege levels, according to client-configurable policy mappings based on the composite risk score. Unlike clustering-based behavioral anomaly systems that measure deviation from organizational peer group norms, the system derives individual behavioral baselines exclusively from each user's own historical access patterns recorded during prior verified sessions, enabling detection of compromised accounts whose attacker behavior may be statistically normal within the peer group but inconsistent with the specific individual's personal baseline. This individual-baseline approach expressly excludes k-means clustering of organizational behavior.

In addition to informing biometric descriptor weighting, the environmental baseline serves a security detection function. The system monitors the physical environment captured by the device camera during active sessions and compares it against the established environmental baseline to detect the presence of unauthorized observers, individuals exhibiting behavior consistent with attempting to photograph or record the device display, and objects with photography or video capture capability directed toward the display. When the system detects a face in the camera field of view that does not correspond to the authenticated user and is oriented toward the display, it classifies this as an unauthorized observer event. When the system detects an object with photography capability, including portable devices with visible camera components, positioned in proximity to and oriented toward the display, it classifies this as a potential screen capture threat. These environmental security events are reported to the security operations interface and contribute to the composite risk score. The configured risk policy for environmental security events may include screen visibility manipulation, session lock, on-screen notification, or administrative alert.

### Multi-Source Enrollment Pipeline

The system supports three enrollment paths, each producing facial descriptor vectors stored in the sovereign central database in association with a user identifier. Path 1: Live First-Login Enrollment: Upon a user's first successful authenticated login to a managed endpoint, the system captures live biometric data from the device camera and associates the extracted facial descriptor vectors with the authenticated user identifier, establishing the initial biometric baseline without requiring a pre-existing headshot. Path 2: Out-of-Band Batch Enrollment: An enrollment application programming interface accepts pairings of a user identifier and a headshot image from external authoritative data sources including human resources management systems, physical access control badging systems, identity verification platforms, and enterprise directory services. The sovereign server extracts facial descriptor vectors from each provided headshot image and stores them against the corresponding user identifier in the sovereign database. This enrollment path does not require physical presence of the user at any managed endpoint. Path 3: Continuous Biometric Learning: During verified sessions in which a Capacity Token has been successfully issued, the system updates stored facial descriptor vectors to reflect natural biometric changes over time. Template updates occur strictly within sessions having confirmed identity and are derived from two-dimensional image capture consistent with the flat facial image architecture of the sovereign database, expressly without generating three-dimensional facial renderings. No updates occur during sessions where identity has not been verified to a successful Capacity Token issuance.

### Remote Session Biometric Verification and Identity and Access Management Integration

The system integrates with Identity and Access Management and Pluggable Authentication Module systems by binding the biometric identity resolution output to the user identifier used by those systems. The biometric identity resolution produces a user identifier that is federated into existing Privileged Access Management and Identity and Access Management systems as an authentication factor, enabling continuous biometric presence verification to operate alongside and augment existing authentication infrastructure. For active remote access sessions, including sessions established via secure shell and similar remote connection protocols, the system enforces continuous biometric presence verification through one of two mechanisms. In the first mechanism, a verification challenge is tunneled through the active session channel to the originating client device, where the local system agent performs biometric verification and returns a result through the session channel. In the second mechanism, an out-of-band verification request is delivered via a secure URL redirect to the originating client device, prompting the agent on that device to perform biometric verification and report the result to the session management server. Upon detection of user absence from the physical keyboard of the managed device-whether the connection is a local physical session or a remotely tunneled session-the system treats the absence as a session revocation trigger and initiates revocation of the session-specific cryptographic token governing outbound network connections.

### Hardware Authentication Device Monitoring

The system monitors hardware authentication devices connected to a managed endpoint and generates security alerts when such devices remain connected in the absence of confirmed biometric user presence. A hardware authentication device as used herein refers to any hardware device connected to the managed endpoint that serves an authentication, authorization, or access control function, including but not limited to universal serial bus security keys, smart cards, hardware one-time password tokens, near-field communication access badges, and hardware security modules. Client-specific sensitive devices may also be incorporated at enterprise configuration. The unattended presence of a connected hardware authentication device without confirmed continuous biometric presence of the associated user identifier constitutes a security event. Upon detection of this condition, the system generates an alert to the security operations interface and applies the risk policy configured for unattended hardware authentication device events, which may include session restriction, elevated authentication challenge, or physical security notification.

### Physiological Liveness Analysis and Synthetic Media Resistance

The system integrates passive physiological liveness signal analysis into the biometric authentication workflow to confirm biological liveness of the detected subject and to resist synthetic media injection attacks. The system analyzes one or more passive physiological signals captured via an optical image sensor without intentional stimulus, including but not limited to: involuntary pupil response characteristics in reaction to ambient luminance conditions; and involuntary facial micro-expression patterns. The system architecture is further designed to accommodate additional categories of passive physiological signals, including involuntary tissue micro-movements detectable via optical sensors, as such detection capabilities become available and are implemented. These signals are analyzed by the deterministic neural network as additional inputs to the physiological capacity analysis alongside the primary biometric comparison. If the analyzed liveness signals are inconsistent with a biological baseline for the enrolled user, the system withholds the Capacity Token as a synthetic media injection countermeasure. The system does not require coherent light sources or specialized retinal scanning sensors to perform this analysis, operating exclusively with standard optical image sensors. This analysis is performed locally at the network edge via the browser-executable sandbox module for unmanaged endpoints, or by the continuous biometric security analytics module on managed endpoints, expressly without transmitting raw video streams. The physiological liveness analysis pipeline operates on the local device camera feed and is distinct from the environmental monitoring function, which analyzes the broader camera field of view for unauthorized observers and photography-capable objects; both analyses draw from the same camera input but serve different detection purposes within the system.

### Physical-Digital Identity Synchronization and Dual-Domain Presence Corroboration

The sovereign central database serves as a unified biometric identity layer accessible to both digital authentication workflows and physical security infrastructure. The system integrates with physical access control systems and video surveillance infrastructure to perform facial biometric verification against the sovereign database using one of two operational modes. In the first mode, the system agent is deployed on a video surveillance central collection server. The agent operates using the same biometric processing pipeline, the same deterministic neural network, and resolves identities against the same sovereign biometric identity database used for digital session Capacity Token management. The agent processes camera feeds to extract facial biometric vectors, queries a local volatile database for identity resolution, and transmits unresolved vectors to the sovereign central server for matching, consistent with the volatile-first resolution architecture described in the IoT and OT Edge Integration section. This architecture is distinct from standard video management system analytics plugins in that the resolved user identifier is the same UID governing active digital sessions, and the physical presence state is maintained in the same sovereign database that issues and revokes Capacity Tokens. In the second mode, a still image captured at a physical access control entry point is transmitted via application programming interface to the sovereign server, which performs in-memory biometric comparison consistent with the sovereign identity database, returns the resolved user identifier, and purges the image and extracted vectors from volatile memory without writing to persistent storage. Upon resolution of a physical access event, whether via biometric verification at the access point or via physical access credential authentication, the system updates the physical presence state for the resolved user identifier in the sovereign database.

### Dual-Domain Presence Corroboration

The system maintains a corroboration state for each enrolled user comprising two independent presence verification records: a physical presence record updated by physical access control events, and a digital presence record updated by biometric verification at managed endpoint login and continuous session monitoring. Both records are maintained in the sovereign central database against the user identifier. A Corroboration Anomaly is defined as a discrepancy between a user's physical presence state and digital session state where both states are maintained in the sovereign central database against the same user identifier. Four Corroboration Anomaly types are defined:
Type 1: Digital session without physical entry corroboration: A valid user identifier establishes a digital session but has no corresponding physical entry event within the configurable corroboration window. Indicates potential credential theft, remote hijacking, or access by a party not physically present.
Type 2: Physical entry without digital session: A user identifier is resolved at a physical entry point but does not establish a digital session within the configurable corroboration window.
Type 3: Location inconsistency: Physical entry was recorded at one facility location but the digital session was established from a device at a geographically inconsistent location.
Type 4: Session continuation after physical departure: A physical exit event is recorded for a user identifier that has an active digital session.

Upon detection of any Corroboration Anomaly, the system applies the configured risk policy, which may include elevated authentication challenge, Capacity Token withholding, session restriction, or security alert transmission.

### Containerized Browser Agent and Thin Client Deployment

The system supports deployment of the continuous biometric verification agent as a containerized application within an enterprise browser environment or on a thin client endpoint device. In this deployment mode, the agent operates within the browser's execution sandbox, accessing camera hardware through browser-exposed hardware application programming interfaces without requiring operating system-level installation. In enterprise browser and thin client deployments, camera access is governed by enterprise-configured policy administered through the browser management platform or thin client configuration, and does not require per-session user approval. Camera access rights are established at deployment time as part of the enterprise browser or thin client configuration profile. Unlike the On-Demand Ephemeral Executable, which is delivered on demand for individual transaction verifications and enforces a zero-footprint state upon each completion, the containerized browser agent maintains persistent session state for the duration of the browser session, continuously issuing and renewing Capacity Tokens bound to the active Identity and Access Management session. The containerized browser agent communicates with the sovereign server using a unique agent registration credential assigned at deployment time and session-specific rotating cryptographic keys, such that the sovereign server can distinguish legitimate agent submissions from spoofed or injected communications originating from unregistered processes within the browser environment. Each agent instance is uniquely registered with the sovereign central server at deployment time. The sovereign server validates both the client registration credential and the current key rotation state for each incoming submission, rejecting any submission from an unregistered agent or one with an invalid key rotation state and logging the event as a potential spoofing attempt. Upon browser session termination, the agent enforces a zero-footprint state by clearing all locally cached biometric data and session-specific cryptographic material. This deployment mode extends continuous biometric verification to virtual desktop infrastructure users, enterprise browser deployments, and thin client environments where a traditional operating system-level agent cannot be installed.

### Security Operations Center Signal Export and Event Management System Integration

The system exports behavioral and biometric presence signals to external Security Operations Center platforms via a push or pull application programming interface using standard data formats configurable to client requirements. Exportable signal types include biometric presence attestation events, Capacity Token issuance and revocation events, User-Behavior Analytics anomaly signals, environmental risk classification events, hardware authentication device unattended alerts, and Corroboration Anomaly events. All signal export occurs via application-layer application programming interfaces calls expressly without modifying network packet headers. User-Behavior Analytics anomaly signals generated by the system are based on deviation of individual user behavior from that individual's own historical baseline derived from prior verified sessions. This individual-baseline approach enables detection of compromised accounts whose attacker behavior may not be detected by peer-group-based anomaly systems.

### Video Proxy Service for Multi-Streaming

To resolve hardware resource contention inherent in continuous monitoring, the system instantiates a video proxy service. This proxy creates a virtual duplicate of the hardware video input process. A multi-streaming controller distributes the video content from a single hardware source to both the continuous security analytics module and a third-party communication application (e.g., Zoom, Microsoft Teams) simultaneously, allowing uninterrupted business operations. The video proxy and stream duplication architecture described herein applies equivalently to inbound remote participant video streams in collaboration sessions, enabling a replication of the far-end video stream that delivers one copy to the collaboration application and a second copy to the biometric analysis pipeline for remote participant identity verification.

### Physics-Based Input Integrity and Driver Enumeration Fallback

To defeat deepfakes and hardware spoofing tools (e.g., HDMI capture cards), the system utilizes a Consistency Analysis Engine to calculate an Input Integrity Score. The engine queries the peripheral device's Reported Capability Profile and compares it to Observed Behavioral Characteristics. Specifically, the system analyzes protocol consistency to verify that a device claiming to be a physical webcam actually utilizes isochronous data transfers with high packet variance, rather than the bulk transfer modes typical of file-based software injection tools. For unmanaged endpoints, the ephemeral executable accesses this deep Hardware Abstraction Layer (HAL) telemetry strictly via browser-exposed hardware application programming interfaces (APIs), maintaining a zero-footprint state. In environments where deep protocol analysis is restricted, the system deploys an on-device executable or script as a fallback mechanism to enumerate local hardware drivers, validate cryptographic driver signatures, and identify software-based video obstruction layers indicative of virtual camera injection. The Input Integrity Score calculation and hardware spoofing detection described herein are applicable to video streams received from remote participants in collaboration sessions, enabling detection of hardware-based video injection, including USB video injectors and HDMI capture cards, used by a remote participant to substitute a synthetic or pre-recorded video feed in place of a live camera input.

### Adaptive Trigger Modulation (Dynamic Censoring)

To ensure usability and prevent the security tool from becoming a denial-of-service vector, the system employs an Adaptive Sensitivity Layer. The system continuously samples device health telemetry, including CPU load and network latency. If the client device is under resource stress and exceeds a predefined stability limit, the system engages Dynamic Censoring, automatically degrading the complexity of the security check (e.g., relaxing thresholds or bypassing deep forensic scanning).

### Topology-Agnostic Multi-Party Authorization Logic

The Configurable Logic Engine orchestrates complex “N-of-M” multi-party approvals across distributed topologies. In a “Sequential Mode,” the engine validates a primary user, stores a pending state, and enforces a Chain of Custody by unlocking the next step exclusively for distinct secondary users. In a “Simultaneous Mode,” the engine enforces Dual Custody or broad multi-party consensus by awaiting valid biometric signals from a plurality of distinct users within a configurable time window, synchronizing inputs whether originating from a co-located endpoint or distributed globally.

### In-Band Collaboration Verification Via Intermediary Gateway

To prevent procedural fraud, impersonation, and social engineering across customer-facing and internal workflows, including telehealth consultations, government document renewals, and remote human resources interviews, the system executes in-band verification of remote participants. The system accesses the video stream of the remote participant through one of three architectural modes.

In the first mode, an intermediary network gateway is positioned in the communication path between the managed device and the remote participant. The gateway receives the collaboration video stream as it transits the network and performs biometric analysis on the stream in-line without interrupting the session.

In the second mode, the system agent is deployed within a corporate virtual asset hosting or staging the collaboration session, including a virtual desktop infrastructure environment, a cloud-hosted conferencing bridge, or a corporate meeting server. The corporate virtual asset receives the incoming video stream from the remote participant as part of the session. The agent operating within the controlled corporate environment accesses that incoming stream and performs biometric analysis on the remote participant's video feed. This mode is particularly applicable where the remote participant is an untrusted party operating an unmanaged BYOD device, such as a contractor, a customer, or a member of the public, whose identity must be verified against the sovereign biometric identity database using an enrollment record from the out-of-band batch enrollment pipeline, including records sourced from human resources management systems, physical access control badging systems, or identity verification platforms. In this mode the system detects attempts by the remote participant to use synthetic media, deepfake technology, or face-swapping tools to impersonate another identity.

In the third mode, the incoming video stream from the remote participant is replicated at a device participating in the collaboration session. A first copy of the replicated stream is delivered to the collaboration application for normal display to the session participant. A second copy is routed to the system biometric analysis pipeline. This mode enables biometric identity verification and synthetic media detection of the remote participant without requiring any modification to the remote participant's device, any prior enrollment action by the remote participant, or any interruption to the displayed call. The replication may occur on the managed endpoint of the representative agent receiving the call or on the managed endpoint of the user receiving a call from an untrusted remote party.

In all three modes, the system performs biometric identity verification by comparing facial descriptor vectors extracted from the accessed video stream against the sovereign biometric identity database to resolve or confirm the remote participant's user identifier. The system additionally analyzes the video stream for passive physiological liveness signals to detect synthetic media injection. If the biometric comparison fails to confirm the claimed identity, or if liveness analysis indicates the video stream is not from a live biological subject, the system generates a verification failure event and applies the configured risk policy, which may include session termination, escalation alert to the representative agent, or notification to the security operations interface.

### Dynamic Helpdesk Verification Via On-Demand Device Redirection

To specifically prevent helpdesk social engineering and unauthorized credential resets, the system provides an active on-demand verification workflow initiated by a remote support agent. During a support interaction, the agent triggers a human verification request directed at the specific device utilized by the user. The central management server determines the management state of the endpoint. If the device is a managed endpoint with an active continuous trust session, the server silently queries the session state and returns an immediate biometric verification confirmation to the agent's dashboard, expressly without interrupting the user. If the device is unmanaged or the continuous session is inactive, the system dynamically generates and transmits a secure redirect request to the user. Upon execution, the system delivers the On-Demand Ephemeral Executable to perform an inline physiological capacity and input integrity verification prior to authorizing the helpdesk agent to proceed.

### Agentless Architecture and Zero-Footprint Edge Extraction

To provide continuous verification for contracted staff operating unmanaged devices (BYOD), the system utilizes an On-Demand Delivery Engine. Upon an application programming interfaces challenge, the engine pushes a browser-executable sandbox module (e.g., WebAssembly) to the client. This executable performs local flat object detection and biometric vector extraction strictly at the network edge, expressly without transmitting raw video streams. Upon conclusion of a session, the executable enforces a zero-footprint state by programmatically clearing Document Object Model (DOM) variables and flushing heap memory allocations.

### Logic Thread Interception (Kernel and User-Space)

The system intercepts state-change requests through one of the following mechanisms: programmatically suspending a host application's execution thread prior to memory commitment; intercepting an application programming interfaces call associated with the state-change request prior to execution; or interrupting a session state transition of the host application prior to committing the state change. If operating with OS privileges, the system utilizes Extended Berkeley Packet Filter (eBPF) hooks or kernel-level callbacks to implement thread suspension or application programming interfaces interception. If operating within an unmanaged sandbox, the system executes user-space interception via application programming interfaces hooking or Document Object Model event interception. This architecture can achieve the same gating outcome through alternative interception mechanisms which remain within the scope of the system.

### Graphical Obfuscation and Hardware Suppression

Upon detecting an anomaly or failed biometric state on a managed device, the system executes an obstruction response consisting exclusively of rendering an application-layer graphical obfuscation overlay. This full-screen overlay programmatically captures and consumes all user interface focus, thereby automatically suppressing keyboard and mouse hardware input events as a direct byproduct to prevent blind data entry. The system operates expressly without altering Advanced Configuration and Power Interface (ACPI) states.

### IoT and OT Edge Integration With Volatile-First Resolution

The system is configurable for Industrial IoT and OT environments, physical access control infrastructure, and video surveillance collection servers. In legacy OT endpoints, the system utilizes an external Small Form Factor (SFF) gateway. For physical access control and video surveillance deployments, the system deploys the system agent on the video surveillance central collection server or equivalent aggregation point, applying the same volatile-first resolution architecture: the agent queries a local volatile database first, and if identity is not resolved locally, transmits facial biometric vectors to the sovereign central server for resolution against the enterprise central database. To ensure performance and autonomy, the edge computing module first queries a local volatile database to identify the human in its proximity. If the identity is not found within the volatile database, the descriptors are transmitted to the sovereign enterprise central server for userID resolution. Upon identification, the system instantly captures forensic evidence and reports related events to corporate security systems comprising at least one of a Security Information and Event Management system, an Identity and Access Management system, or a physical access control management system.

### Other Embodiments

In embodiments, the disclosure also provides an edge-based security system for continuous identity enumeration and authorization of Operational Technology and Internet of Things endpoints, comprising a primary Operational Technology or Internet of Things asset; an edge computing module positioned in physical proximity to the primary asset, configured to continuously capture facial biometric vectors and execute a deterministic neural network locally to verify a human presence; a local volatile database stored within the edge computing module; and a central management server sovereign to an enterprise and communicatively coupled to an enterprise central database and the edge computing module, configured to: direct the edge computing module to query the local volatile database first to identify the human presence; if identity is not resolved via the local volatile database, receive the facial biometric vectors from the enterprise central database associated to the userID and match them against facial biometric vectors on the edge computing module; and transmit the resolved userID, and related events to a corporate security system comprising at least one of a Security Information and Event Management or an Identity and Access Management system to enable responsive actions.

The edge-based security system can also include wherein the edge computing module comprises an external Small Form Factor computing device acting as an intermediary hardware gateway for a legacy Operational Technology asset incapable of hosting native continuous biometric software. The edge-based security system can also include wherein the edge computing module comprises a client agent embedded natively within a device operating system of a modern Internet of Things asset. The edge-based security system can also include wherein the edge computing module is further configured to transmit a physical or logical actuation signal to the primary Operational Technology or Internet of Things asset to interrupt or permit operation based strictly on an authorization state dictated by the corporate security system.

The disclosure further provides a method for populating a sovereign biometric identity database comprising: receiving, at a sovereign server, one or more pairings of a user identifier and a headshot image from an external authoritative data source comprising at least one of a human resources management system, a physical access control badging system, an identity verification platform, or an enterprise directory service; extracting facial descriptor vectors from each headshot image within the sovereign server; storing the extracted facial descriptor vectors in association with the corresponding user identifier in the sovereign biometric identity database; making the stored facial descriptor vectors available for identity resolution during subsequent biometric authentication events on managed endpoints, Internet of Things and Operational Technology assets, and physical access control infrastructure; wherein the enrollment process does not require physical presence of the user at any managed endpoint.

The disclosure further provides a unified biometric identity system comprising: a sovereign central server configured to maintain a sovereign biometric identity database and execute biometric matching exclusively within volatile memory without writing biometric vectors or raw image data to persistent storage, wherein administrative access, biometric data governance, and security policy authority of the sovereign central server are controlled by or exclusively on behalf of an enterprise client; a first consumer interface configured to receive biometric verification events from managed computing endpoints and issue or revoke session-specific cryptographic Capacity Tokens based on continuous biometric presence verification; a second consumer interface configured to receive biometric verification events from physical security infrastructure comprising at least one of physical access control entry points and video surveillance collection servers, and update a physical presence state for each resolved user identifier in the sovereign biometric identity database; a third consumer interface configured to receive biometric verification events from edge computing modules deployed in proximity to Operational Technology or Internet of Things assets; a fourth consumer interface configured to receive continuous biometric verification events from containerized agents deployed within enterprise browser environments or virtual desktop infrastructure sessions; a dual-domain corroboration engine configured to cross-validate physical presence states and digital session states for the same user identifier and generate Corroboration Anomaly signals when the states are inconsistent within a configurable corroboration window; and a security operations interface configured to transmit biometric presence attestation events, Corroboration Anomaly signals, User-Behavior Analytics anomaly signals, and Capacity Token events to at least one external security information and event management platform via application-layer application programming interfaces calls.

The disclosure further provides a system for enterprise-scale continuous biometric authentication on a managed computer device, comprising: a continuous biometric security analytics module configured to continuously capture real-time facial descriptors from a device camera and execute a deterministic neural network to verify a human presence against a known baseline; a session management component configured to dynamically bind outbound network connections originating from the managed device to a session-specific cryptographic token and revoke said token upon failure of the continuous trust session; an adaptive environmental descriptor weighting engine configured to dynamically adjust the weighting of biometric descriptors based on current environmental conditions and assign risk classifications to known, modified, and novel environments; and a sovereign central server communicatively coupled to the managed device, configured to execute biometric matching exclusively within volatile memory, maintain the sovereign biometric identity database, and issue or revoke Capacity Tokens based on physiological capacity analysis results.

In embodiments, the disclosure further provides a non-transitory computer-readable medium containing instructions that, when executed by a processor, cause the processor to: receive a state-change request associated with a Single Sign-On session, the request comprising a Session Origin Vector identifying a computing environment; intercept the state-change request by one of: suspending an execution thread of a host application prior to memory commitment; intercepting an application programming interfaces (API) call associated with the state-change request prior to execution; or interrupting a session state transition of the host application prior to committing the state change; deliver an On-Demand Ephemeral Executable comprising a browser-executable sandbox module to a client interface; execute local flat object detection and biometric vector extraction at a network edge via said browser-executable sandbox module, without transmitting raw video streams over a network; analyze physiological telemetry via a deterministic neural network to detect capacity anomalies, wherein the deterministic neural network operates without Large Language Models; generate a Capacity Token upon successful physiological analysis and cryptographically bind the Capacity Token to the Session Origin Vector; and release the suspension of the execution thread upon confirmation of the bound Capacity Token.

### Glossary

Split-Session Anomaly is defined as a discrepancy between a telemetry source of the Capacity Token and the Session Origin Vector of the state-change request, indicating that the biometric verification that produced the Capacity Token originated from a different computing environment than the environment from which the state-change request was submitted.

A Session Origin Vector as used herein refers to a structured identifier associated with a state-change request that specifies the computing environment of origin, comprising at minimum the management state of the originating device (managed endpoint, BYOD unmanaged device, IoT/OT asset, or physical access control infrastructure), the network topology classification, and session metadata sufficient to uniquely identify the originating session context.

A browser-executable sandbox module as used herein refers to a self-contained executable module delivered to and executed within a web browser's isolated execution environment, including but not limited to a WebAssembly module, a browser extension, or a containerized browser agent, that performs biometric vector extraction and physiological analysis locally on the client device without persistent installation on the host operating system and without direct access to host operating system resources outside the browser's security sandbox. In enterprise browser and thin client deployments, camera access by the browser-executable sandbox module is governed by enterprise-administered browser policy rather than by per-session user consent prompts.

A deterministic neural network as used herein refers to a neural network that produces a consistent, reproducible output for a given input without probabilistic or stochastic sampling layers, operating without Large Language Model architectures, without generative adversarial network components, and without diffusion model components. The deterministic neural network as used herein is specifically configured for biometric feature extraction and physiological capacity classification, and produces a binary or scored authentication output for a given biometric input rather than generating synthetic media or natural language responses.

Large Language Models as used herein refers to transformer-based generative artificial intelligence models trained on large natural language corpora primarily for natural language generation, completion, or instruction-following tasks. The claimed deterministic neural network expressly excludes Large Language Model architectures. This exclusion distinguishes the claimed system from authentication approaches that rely on probabilistic generative models for biometric analysis.

A Capacity Token as used herein refers to a cryptographic token generated by the system upon successful completion of physiological capacity analysis and biometric identity verification, cryptographically bound to the Session Origin Vector of the associated state-change request, that authorizes the release of a suspended host application execution thread and governs the validity of outbound network connections for the duration of the authenticated session. The Capacity Token is revoked upon detection of a Split-Session Anomaly, a Corroboration Anomaly, a failed continuous biometric re-verification, or sovereign server-directed session termination.

Physiological telemetry as used herein refers to passive biometric signals captured from a human subject via an optical image sensor without intentional stimulus, including but not limited to pupil constriction velocity in response to ambient environmental luminance shifts, facial geometry measurements, and involuntary facial micro-expression patterns. Physiological telemetry expressly excludes data collected using coherent light sources or specialized retinal scanning sensors of the type used in iris recognition or ophthalmological imaging systems.

Device health telemetry as used herein refers to real-time operational metrics of a client computing device sampled by the system to assess device resource availability, including but not limited to central processing unit utilization percentage, available memory, network connection latency, and storage input/output load. Device health telemetry is used by the Adaptive Trigger Modulation mechanism to determine whether the complexity of the physiological analysis should be dynamically censored to prevent the authentication system from becoming a denial-of-service vector on a resource-constrained device.

Physiological capacity analysis as used herein refers to the process of analyzing physiological telemetry captured from a detected subject to determine whether the subject demonstrates biological liveness and physiological characteristics consistent with the enrolled user's known baseline, and to detect synthetic media injection or other non-biological input. Physiological capacity analysis includes but is not limited to passive pupillometry, facial geometry comparison against a known baseline, physiological liveness signal analysis, and Adaptive Environmental Descriptor Weighting. The output of physiological capacity analysis is a determination of whether the Capacity Token should be issued or withheld.

An Identity and Access Management system as used herein refers to an enterprise platform that manages digital identities, authentication credentials, and access control policies for users and devices within an organization, including but not limited to directory services, single sign-on platforms, and privileged access management systems. The system integrates with Identity and Access Management systems by providing verified biometric presence attestation as an input to the Identity and Access Management authentication decision and by receiving user identifier and group membership information from the Identity and Access Management system for enrollment and session governance.

Real-time facial descriptors as used herein refers to mathematical vector representations of facial geometry extracted from live video frames or still images captured during an active session or at a physical access point, updated on a continuous or periodic basis to reflect the current state of the detected subject. Real-time facial descriptors are compared against stored algorithmic baselines to verify continuous identity during an active session.

A continuous trust session as used herein refers to an authenticated user session on a managed endpoint in which the deterministic neural network continuously verifies human presence against a known baseline without relying on time-decaying confidence metrics. A continuous trust session remains valid as long as biometric verification succeeds at each re-check interval and no anomaly condition is detected. A continuous trust session is terminated upon failed biometric re-verification, detection of a Split-Session Anomaly, detection of a Corroboration Anomaly, physical departure of the user from the managed endpoint, or sovereign server-directed revocation.

A continuous biometric security analytics module as used herein refers to the software component deployed on a managed endpoint responsible for ongoing biometric capture from the device camera, extraction of real-time facial descriptors, physiological capacity analysis, environmental baseline collection and classification, adaptive descriptor weighting, anomaly scoring, and Capacity Token status management during an active session.

Distributed geographic endpoints as used herein refers to managed computing devices, IoT or OT assets, or physical access control infrastructure located in geographically separated physical locations that are communicatively coupled to the sovereign central server via a network, and that are each subject to the same biometric authentication policies administered by that server.

User-Behavior Analytics as used herein refers to the collection and analysis of historical user access patterns to establish an individual behavioral baseline and detect statistically anomalous deviations from that baseline. As used herein, the behavioral baseline is derived exclusively from each individual user's own historical access patterns recorded during prior established continuous trust sessions having a verified human presence, and expressly not from peer group norms or organizational cluster comparisons. Anomalous deviations from the individual baseline generate risk signals that contribute to the composite risk score and are available for export to Security Information and Event Management platforms.

An external Identity Provider as used herein refers to a third-party authentication and authorization service that manages user identity tokens for access to one or more applications or services, including but not limited to single sign-on platforms and federated identity services. The system operates as a continuous presence attestation oracle to external Identity Providers by receiving presence validation polling requests and transmitting a real-time binary presence attestation state based on the active continuous trust session, without embedding authentication objects into network packet headers.

A real-time binary presence attestation state as used herein refers to a boolean signal transmitted to an external Identity Provider or security platform indicating solely whether a verified biometric human presence is currently confirmed for the associated user identifier on the managed endpoint, based on the active continuous trust session. The real-time binary presence attestation state does not include biometric data, facial descriptors, or personally identifiable information beyond the user identifier.

A cryptographically hashed evidentiary package as used herein refers to a tamper-evident record assembled by the forensic capture agent comprising: a pre-event screen state capture, one or more environmental still images from the device camera, the biometric verification result for each relevant user identifier, and transaction metadata including the user identifier, session token identifier, timestamp, and device identifier; to which a cryptographic signature is applied by the sovereign central server using a client-unique signing key held exclusively by the sovereign server. The client-unique signing key is not accessible to the endpoint agent or to the user whose actions are recorded, establishing non-repudiation of the recorded transaction. Any post-signing modification to the package content invalidates the signature. The architecture is compatible with integration of third-party trusted timestamp authorities compliant with RFC 3161 for deployments requiring independent temporal attestation.

A Corroboration Anomaly as used herein refers to a discrepancy between a user's physical presence state as recorded by physical access control or video surveillance infrastructure and the user's digital session state, where both states are maintained in the sovereign central database against the same user identifier. Corroboration Anomaly types include: Type 1 (digital session without corroborating physical entry), Type 2 (physical entry without subsequent digital session), Type 3 (physical entry location inconsistent with digital session device location), and Type 4 (physical exit detected during active digital session).

A Corroboration Window as used herein refers to a configurable time parameter defining the maximum permitted elapsed time between a physical access control entry event and a digital session establishment event for the same user identifier before the absence of corroboration is classified as a Corroboration Anomaly. A hardware authentication device as used herein refers to any hardware device connected to a managed endpoint that serves an authentication, authorization, or access control function, including but not limited to universal serial bus security keys, smart cards, hardware one-time password tokens, near-field communication access badges, and hardware security modules. A sovereign biometric identity database as used herein refers to the centralized database maintained by the sovereign central server containing enrolled facial descriptor vectors, user identifiers, physical presence state records, digital session state records, environmental baseline profiles, and User-Behavior Analytics baselines for enrolled users, processed exclusively within volatile memory during verification operations without writing biometric vectors or raw image data to persistent storage.

An intermediary network gateway as used herein refers to any hardware, software, or cloud-based system positioned in the communication path between a managed endpoint and a remote party, through which data traffic passes in transit, and which is configured to inspect, analyze, or act upon that traffic. The intermediary network gateway may be implemented as a physical network appliance, a software-defined network function, a cloud-based proxy or relay service, a session border controller, a media server, or any other system that receives, processes, and forwards communications between two endpoints without being the originating or terminating endpoint of the communication.

A corporate virtual asset as used herein refers to a computing environment controlled by or on behalf of an enterprise that hosts, stages, or mediates a collaboration session, including but not limited to virtual desktop infrastructure environments, cloud-hosted conferencing bridges, corporate meeting servers, and hosted collaboration platforms through which remote participants connect to enterprise-controlled sessions.

A far-end video stream replication as used herein refers to the duplication of an incoming video stream received from a remote participant at a device participating in a collaboration session, producing a first copy for delivery to the collaboration application and a second copy for delivery to a biometric analysis pipeline, such that biometric analysis of the remote participant occurs without interrupting the displayed session and without any modification to the remote participant's device.

A Reported Capability Profile as used herein refers to the set of hardware capability descriptors and device characteristics that a peripheral device reports to the host operating system or browser hardware abstraction layer (HAL), including device type, data transfer protocol declarations, and capability assertions, which may or may not accurately reflect the device's actual physical hardware, and which is used by the system to compare against Observed Behavioral Characteristics to detect inconsistencies indicative of hardware spoofing or virtual camera injection.

Observed Behavioral Characteristics as used herein refers to the actual measured operational behavior of a peripheral device as detected by the system during operation, including data transfer patterns, protocol timing characteristics, packet variance profiles, and transfer mode behaviors, used in comparison against the device's Reported Capability Profile to determine whether the device is operating consistently with its claimed hardware type or is exhibiting behavior indicative of a software-based injection tool.

An Input Integrity Score as used herein refers to a numerical value calculated by the Consistency Analysis Engine representing the probability that a peripheral device is a genuine physical sensor rather than a software injection tool or virtual camera, derived by comparing the device's Reported Capability Profile against its Observed Behavioral Characteristics, wherein a higher score indicates greater consistency between reported and observed behavior and a lower score indicates a higher probability of hardware spoofing.

A Physics-Based Input Integrity Score as used herein refers to an Input Integrity Score that incorporates analysis of physical transmission characteristics specific to hardware sensor devices, including isochronous data transfer patterns with high packet variance that are characteristic of physical camera sensors operating at real-time frame rates, as distinguished from the bulk data transfer modes characteristic of file-based software video injection tools, wherein the physical transmission signature is used to verify that a device reporting itself as a camera is behaving in a manner consistent with a physical optical sensor.

A Chain of Custody as used herein refers to the sequential enforcement of multi-party authorization in which each step in a restricted transaction sequence is unlocked exclusively for a distinct secondary user only after the preceding participant's biometric verification has been confirmed and recorded, ensuring that no single user can complete all authorization steps independently and that each step is attributable to a verified and individually identified participant, thereby establishing an auditable record of sequential approvals.

Adaptive Trigger Modulation as used herein refers to the dynamic adjustment of the complexity and computational scope of the physiological analysis performed by the system in response to real-time device health telemetry, wherein the system automatically degrades the depth of the security check when sampled device health telemetry indicates that processor load or network latency exceeds a predefined stability limit, reducing the computational burden on the client device to prevent the authentication system from becoming a denial-of-service vector, and wherein the system restores full analysis complexity when telemetry indicates that device resource availability has returned within acceptable bounds.

In-band verification as used herein refers to biometric identity verification performed using a video stream that is already active and transmitting as part of an ongoing collaboration session, without requiring the subject of verification to initiate a separate authentication event, install any software, or register any device in advance, and without interrupting or modifying the collaboration session itself, wherein the verification process operates on the existing session video stream as its sole biometric input source.

An intermediary network gateway as used herein refers to any hardware appliance, software-defined network function, cloud-based proxy or relay service, session border controller, media server, or other system that is positioned in the communication path between two session endpoints such that data traffic passes through it in transit, and which is configured to inspect, analyze, or act upon that traffic without being the originating or terminating endpoint of the communication, including but not limited to reverse proxy servers, cloud access security brokers, and enterprise network edge appliances.

A corporate virtual asset as used herein refers to a computing environment that is controlled by or on behalf of an enterprise and that hosts, stages, or mediates a collaboration session, including but not limited to a virtual desktop infrastructure (VDI) environment, a cloud-hosted conferencing bridge, a corporate meeting server, a hosted collaboration platform, or a virtual machine through which remote participants connect to an enterprise-controlled session, wherein the enterprise maintains administrative control over the environment and the software executing within it.

Far-end video stream replication as used herein refers to the duplication of an incoming video stream received from a remote participant at a device participating in a collaboration session, producing a first copy delivered to the collaboration application for normal display and a second copy delivered to a biometric analysis pipeline for identity verification, such that biometric analysis of the remote participant is performed without interrupting the displayed session, without modifying the video stream received by the local participant, and without requiring any action by or modification to the remote participant's device.

An administrative trigger as used herein refers to a signal initiated by an authorized system administrator or remote support agent through the central management server interface requesting on-demand biometric verification of a specific user during an active support interaction, distinct from automated system-generated verification events initiated by the continuous trust session or biometric anomaly detection, and requiring valid administrative credentials for initiation.

A configurable confidence window as used herein refers to a client-defined time parameter specifying the maximum elapsed time since the most recent successful biometric verification within an active session-whether from a continuous trust session, a persistent enterprise browser agent, or a prior on-demand capture-within which the existing verification state is considered sufficiently current to satisfy a helpdesk verification request without requiring a fresh biometric capture, and beyond which the system treats the verification state as lapsed and initiates an on-demand capture to obtain a current result.

A verification path as used herein refers to the specific biometric verification mechanism selected by the central management server in response to a helpdesk verification trigger, determined by evaluating the management state of the user's device and the availability and currency of active verification components in the following priority order: a continuous trust session on a fully managed endpoint, an enterprise browser agent session with a current verification state within the configurable confidence window, and an on-demand biometric capture via whichever agent type is available on the device.

A persistent containerized agent as used herein refers to a browser-executable software module packaged as a self-contained containerized application that maintains continuous operational state and performs ongoing biometric verification for the duration of a browser session, as distinguished from an On-Demand Ephemeral Executable which is delivered for individual transaction verifications and cleared upon completion of each verification event, wherein the persistent containerized agent retains session state, enrolled descriptor references, and cryptographic session material continuously across multiple transaction events within the same browser session.

An enterprise browser environment as used herein refers to a managed web browser deployment administered by an enterprise in which browser behavior, security policy, installed extensions or agents, and hardware access permissions including camera access are governed by enterprise-configured policy applied through a browser management platform rather than by individual user configuration or per-session user consent, such that software agents operating within the enterprise browser environment may access device hardware resources in accordance with the enterprise-administered policy without requiring explicit user approval at the time of access.

A virtual desktop infrastructure session as used herein refers to a computing session delivered from a centralized server infrastructure to a thin client or endpoint device, wherein the computing environment including the operating system, installed applications, hardware access policies, and security configuration is hosted and administered centrally by the enterprise, and the endpoint device functions as a display and input relay for the centrally hosted environment, such that software agents executing within the virtual desktop infrastructure session operate under the security and hardware access policy of the centrally administered environment.

Enterprise-administered browser policy as used herein refers to the set of configuration rules, permissions, and restrictions applied to an enterprise browser environment by an enterprise administrator through a browser management platform, governing browser behavior including but not limited to permitted extensions, hardware access rights, security settings, and camera access permissions for installed agents, wherein such policy is applied at the enterprise level and supersedes individual user configuration preferences for devices and sessions operating under enterprise management.

An on-demand biometric capture as used herein refers to a biometric image acquisition initiated at a specific moment by a system or administrative trigger, as distinguished from the continuous biometric capture performed by an active continuous trust session or persistent browser agent, wherein the device camera is accessed at the time of the trigger, a facial image is captured, facial biometric descriptor vectors are extracted from the captured image, and those vectors are compared against enrolled descriptor vectors for the claimed user identifier in the sovereign biometric identity database to produce a point-in-time identity verification result.

An authoritative external data source as used herein refers to a data system maintained by an organization that holds verified identity records associating user identifiers with identity attributes including headshot images, and that is recognized by the enterprise as an authoritative record of user identity, including but not limited to human resources management systems, physical access control badging systems, identity verification platforms that have performed know your customer (KYC) verification, and enterprise directory services, wherein records from such sources are considered sufficiently reliable to seed the sovereign biometric identity database for subsequent biometric authentication without requiring the user to be physically present at a managed endpoint.

A physical access control event as used herein refers to a recorded event generated by a physical access control system at a physical entry or exit point, comprising at least a user identifier resolved from an access credential or biometric verification, a timestamp, and a location identifier, wherein the user identifier may be resolved through biometric verification against the sovereign biometric identity database, through authentication of a physical access credential such as a proximity badge or smart card, or through a combination thereof, and which is stored in the sovereign biometric identity database as the physical presence record for the associated user identifier.

A consumer interface as used herein refers to a communication and processing component of the unified sovereign hub system configured to receive biometric verification events from a specific category of endpoint or infrastructure, update the associated presence state records in the sovereign biometric identity database, and issue or revoke Capacity Tokens or presence state updates in response to verification results, wherein distinct consumer interfaces serve distinct endpoint categories including managed computing endpoints, physical security infrastructure, operational technology and Internet of Things assets, and enterprise browser and virtual desktop infrastructure environments.

An environmental baseline as used herein refers to a reference profile of the physical environment surrounding a managed endpoint's camera, established by the continuous biometric security analytics module during an initial enrollment phase or upon first verified session in a given location, comprising recorded characteristics including ambient lighting conditions, background object signatures within the camera field of view, and environmental factors that influence the reliability of individual biometric descriptor types, against which subsequent environmental observations are compared to classify the current environment as known, modified, or novel.

A known environment as used herein refers to an environment classification assigned by the Adaptive Environmental Descriptor Weighting Engine when the current environmental state captured by the continuous biometric security analytics module matches a stored environmental baseline within configured tolerances, indicating that the physical conditions surrounding the endpoint are consistent with previously verified sessions and that no elevated risk adjustment to authentication thresholds is warranted on the basis of environmental change.

A modified environment as used herein refers to an environment classification assigned by the Adaptive Environmental Descriptor Weighting Engine when the current environmental state shows significant deviation from the stored environmental baseline for that endpoint location, indicating a material change in the physical conditions surrounding the endpoint such as changes in lighting, background, or other environmental factors, which triggers an elevated risk classification and increased authentication scrutiny thresholds until the modified conditions are either verified and incorporated into an updated baseline or flagged as a security concern.

A novel environment as used herein refers to an environment classification assigned by the Adaptive Environmental Descriptor Weighting Engine when no corresponding environmental baseline record exists for the current physical location or environmental conditions, indicating that the endpoint is operating in a previously unencountered environment, which triggers the highest risk classification level and the most stringent authentication scrutiny thresholds, and for which a new baseline record is created upon successful identity verification in the novel environment.

A risk classification as used herein refers to a categorical designation assigned by the system to a current environmental state, a behavioral anomaly, a Corroboration Anomaly, or a combination thereof, representing the assessed level of security concern associated with that condition, wherein the risk classification drives automatic adjustment of device response configurations including authentication complexity requirements, session timeout parameters, and access privilege levels according to client-configurable policy mappings, and wherein the available risk classification levels and their corresponding policy responses are configurable by the enterprise administrator.

A physical presence state as used herein refers to a record maintained in the sovereign biometric identity database for each enrolled user identifier, representing the most recently determined physical location and access status of the user as detected by physical access control infrastructure or video surveillance systems, comprising at minimum the user identifier, the timestamp of the most recent physical access control event, the location identifier of the most recent entry or exit point, and the direction of transit, updated in real time as physical access control events are received and used by the dual-domain corroboration engine to cross-validate against the user's digital session state.

A digital session state as used herein refers to a record maintained in the sovereign biometric identity database for each enrolled user identifier, representing the current status of any active digital sessions associated with that user identifier, comprising at minimum the user identifier, the session-specific cryptographic token, the Session Origin Vector of the active session, the timestamp of the most recent successful biometric verification within the session, and the current Capacity Token status, updated in real time as biometric verification events and session management events are received and used by the dual-domain corroboration engine to cross-validate against the user's physical presence state.

Volatile-first resolution as used herein refers to the identity resolution strategy employed by edge computing modules and physical security infrastructure agents wherein the module first queries a local volatile database stored within the edge computing module to attempt identity resolution from locally cached facial biometric descriptor vectors before transmitting captured vectors to the sovereign central server, such that identity resolution for frequently encountered users occurs locally without network latency, while identity resolution for unrecognized individuals falls back to the sovereign central server's enterprise central database, minimizing both latency and network traffic while maintaining access to the full enrolled user population.

A zero-footprint state as used herein refers to a condition enforced by the system upon completion of a verification session or termination of a browser session in which all locally retained data associated with the biometric verification process is actively purged from the client device, including but not limited to Document Object Model (DOM) variables, browser-executable sandbox heap memory allocations, locally cached facial biometric descriptor vectors, session-specific cryptographic keys and Capacity Token state, and any intermediate biometric processing data, such that no biometric data, identity information, or session credentials remain on the client device after the session concludes, without writing any such data to persistent storage at any point during the purge process.

Session-specific rotating cryptographic keys as used herein refers to cryptographic keys generated or derived for a specific communication session between a spialert agent and the sovereign central server, wherein the key material is refreshed at each session initiation and is not reused across sessions, such that interception of communications from one session does not provide an adversary with key material valid for any other session, and wherein the sovereign central server validates that the key material presented by an agent corresponds to the current rotation state registered for that agent's unique client credential, rejecting any submission that presents key material inconsistent with the expected current rotation state.

A security event as used herein refers to a condition detected by the system that indicates a potential security concern requiring a response action, including but not limited to detection of a hardware authentication device remaining connected to a managed endpoint in the absence of confirmed biometric presence of the associated user identifier, detection of a Corroboration Anomaly between physical presence state and digital session state, detection of a Split-Session Anomaly, failure of continuous biometric re-verification, detection of synthetic media injection, and environmental risk classification changes indicating a modified or novel environment, wherein each category of security event has a corresponding configurable risk policy determining the system's response action.

Continuous biometric template learning as used herein refers to the process by which the system incrementally updates stored facial descriptor vectors for an enrolled user identifier during verified sessions in which a Capacity Token has been successfully issued, to reflect natural biometric changes occurring over time such as changes in appearance, aging, or environmental variation, wherein updates are derived exclusively from two-dimensional image capture consistent with the flat facial image architecture of the sovereign biometric identity database, expressly without generating three-dimensional facial renderings, and wherein no updates to enrolled descriptor vectors occur during sessions in which identity has not been verified to a successful Capacity Token issuance.

A client-unique cryptographic signing key as used herein refers to a cryptographic key held exclusively by the sovereign central server and associated with a specific enterprise client account, used to apply a digital signature to a cryptographically hashed evidentiary package assembled for that client, wherein the key is not accessible to the endpoint agent, the user whose actions are recorded, or any party other than the sovereign central server, such that the resulting signed package can only have been produced by the sovereign central server at the moment of assembly, establishing non-repudiation of the recorded transaction by preventing the subject of the record from generating or invalidating the signature independently.

A state-change request as used herein refers to a request initiated by a host application or session management component to transition a computing session from one operational state to another, including but not limited to a login event, a privilege escalation request, a transaction authorization request, a session token exchange, a data access request requiring elevated authorization, or a service-to-service authentication handoff, which constitutes a trigger point at which the system intercepts execution to enforce physiological capacity verification prior to permitting the state change to be committed to memory.

A host application as used herein refers to any software application executing on a managed or unmanaged computing device whose execution thread is subject to interception by the system at the point of a state-change request, including but not limited to web browsers, enterprise software applications, Single Sign-On (SSO) clients, remote access clients, virtual desktop clients, and any application participating in an Identity and Access Management (IAM) workflow, wherein the system intercepts the application's execution thread prior to memory commitment of the state change regardless of whether the application is aware of or designed to interact with the biometric verification system.

A sovereign central server as used herein refers to a server whose administrative access, biometric data governance, and security policy authority are controlled by or exclusively on behalf of the enterprise client, regardless of the physical hosting location of the server, including on-premises deployment within the enterprise's own infrastructure and hosted deployment operated by a service provider under contractual data governance obligations to the enterprise, wherein the sovereign central server is deployable as a containerized application in a client-managed environment or as a hosted service, is horizontally scalable according to enterprise requirements, and executes all biometric matching operations exclusively within volatile memory without writing biometric vectors or raw image data to persistent storage at any layer.

An algorithmic baseline as used herein refers to a set of mathematical parameters derived by the sovereign central server from a successfully verified facial biometric comparison, representing a model of the enrolled user's facial characteristics calibrated to the specific environmental and camera conditions of the verifying device, which is transmitted to the local edge device to enable subsequent continuous biometric tracking without requiring transmission of the full enrolled biometric template to the edge device, and which is used by the edge device's deterministic neural network to perform ongoing presence verification against the verified identity.

A Single Sign-On session as used herein refers to an authenticated session established through a centralized identity management system that grants a user access to multiple applications or services using a single set of verified credentials, wherein the session-specific cryptographic token issued by the system upon successful physiological capacity analysis governs the user's access to connected applications for the duration of the session without requiring separate authentication for each application, and wherein revocation of the session-specific cryptographic token by the system terminates the user's access across all applications connected to the Single Sign-On session.

A userID and user identifier as used herein refers to a unique identifier assigned to an individual user within an enterprise identity management system and maintained in the sovereign biometric identity database in association with that user's enrolled facial biometric descriptor vectors, wherein the userID serves as the persistent link between the user's biometric identity and their access credentials, session tokens, behavioral baselines, physical presence state, and digital session state across all deployment domains of the system, and wherein the userID may take any form recognized by the enterprise Identity and Access Management system including but not limited to an alphanumeric employee identifier, a directory account name, a badge identifier, or a verified identity token from an external identity verification platform, provided that the identifier uniquely distinguishes one enrolled individual from all others within the sovereign biometric identity database.

An unauthorized observer event as used herein refers to a security event classified by the system upon detection of a face in the camera field of view of a managed endpoint that does not correspond to the authenticated user identifier and is oriented toward the device display, indicating the potential presence of an individual viewing protected screen content without authorization.

A screen capture threat as used herein refers to a security event classified by the system upon detection of an object with photography or video capture capability positioned in proximity to and oriented toward the display of a managed endpoint, indicating a potential attempt to photograph or record the content visible on the device display.

A computer device is any device capable of processing data and/or information, such as any general purpose and/or special purpose computer, such as a desktop computer, workstation, server, minicomputer, mainframe, supercomputer, computer terminal, laptop, wearable computer, and/or Personal Digital Assistant (PDA), mobile terminal, Bluetooth device, communicator, “smart” phone, messaging service (e.g., Blackberry) receiver, cellular telephone, a traditional telephone with a display screen, telephonic device, or any virtual instances of the aforementioned computer devices. In general, any computer device with memory and one or more processors, and a graphical user interface, may be a computer device. A computer device can comprise components such as one or more network interfaces, one or more processors, one or more memories containing instructions, and/or one or more input/output (I/O) devices, one or more user interfaces coupled to an I/O device, etc. Input/output (I/O) devices are any sensory-oriented input and/or output device, such as an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, haptic device, vibrator, tactile simulator, and/or tactile pad, potentially including a port to which an I/O device can be attached or connected.

Video analytics are computer analytics used to obtain and analyze facial data and object data and typically use machine learning and artificial intelligence (AI) technologies.

While this disclosure includes specific examples, it will be apparent after an understanding of the disclosure of this application has been attained that various changes in form and details may be made in these examples without departing from the spirit and scope of the claims and their equivalents.

1. A method for securing physical and remote computing sessions via agentless continuous physiological capacity enforcement, the method comprising:
receiving a state-change request associated with a Single Sign-On session, the request comprising a Session Origin Vector identifying a computing environment;
intercepting the state-change request by one of: suspending an execution thread of a host application prior to memory commitment; intercepting an application programming interfaces call associated with the state-change request prior to execution; or interrupting a session state transition of the host application prior to committing the state change;
delivering an On-Demand Ephemeral Executable comprising a browser-executable sandbox module to a client interface;
executing local flat object detection and biometric vector extraction at a network edge via said browser-executable sandbox module, without transmitting raw video streams over a network;
analyzing physiological telemetry via a deterministic neural network to detect capacity anomalies, wherein the deterministic neural network operates without Large Language Models;
generating a Capacity Token upon a successful physiological analysis and cryptographically binding the Capacity Token to the Session Origin Vector; and
releasing the intercepted state-change request upon confirmation of the bound Capacity Token.

2. The method of claim 1, further comprising applying Adaptive Trigger Modulation by continuously sampling device health telemetry, wherein a complexity of the physiological analysis is dynamically censored if the device health telemetry indicates a processor load or network latency exceeds a predefined stability limit.

3. The method of claim 1, further comprising calculating, via the browser-executable sandbox module, an Input Integrity Score by comparing a Reported Capability Profile of a peripheral device against Observed Behavioral Characteristics,
wherein the calculating comprises analyzing protocol consistency via browser-exposed hardware application programming interfaces to verify that the peripheral device utilizes isochronous data transfers indicative of a physical sensor rather than bulk data transfers indicative of a software injection tool, or
executing an on-device script to enumerate local drivers, validate cryptographic driver signatures, and identify software-based video obstruction layers.

4. The method of claim 1, wherein analyzing physiological telemetry comprises detecting one or more passive physiological liveness signals from the detected subject using an optical image sensor without intentional stimulus, the liveness signals comprising at least one of: involuntary pupil response characteristics in reaction to ambient luminance conditions; or involuntary facial micro-expression patterns; wherein the detected liveness signals are compared against a biological baseline for the enrolled user, and wherein the Capacity Token is withheld if the detected liveness signals are inconsistent with the biological baseline, thereby resisting synthetic media injection.

5. The method of claim 1, further comprising invalidating the Single Sign-On session upon detecting a Split-Session Anomaly.

6. The method of claim 1, further comprising enforcing a zero-footprint state on the client interface by programmatically wiping Document Object Model variables and flushing browser-executable sandbox heap memory upon completion of the state-change request.

7. The method of claim 1, further comprising executing an on-demand helpdesk verification workflow during a live support interaction, comprising:
receiving an administrative trigger from a remote support agent requesting human verification of a user;
transmitting a secure redirect request to the user; and
upon execution of the secure redirect request by the user, dynamically delivering the On-Demand Ephemeral Executable to the client interface to execute the physiological capacity analysis and the local flat object detection inline with the live support interaction, and
transmitting the Capacity Token to a dashboard of the remote support agent to authorize a support action.

8. The method of claim 1, wherein upon unavailability of the sovereign central server, the system suspends Capacity Token issuance and defers to the authentication state managed by the enterprise Identity Provider for the duration of the unavailability, and resumes biometric verification and Capacity Token issuance upon sovereign server restoration.

9. The method of claim 1, wherein the browser-executable sandbox module is a persistent containerized agent deployed within an enterprise browser environment or virtual desktop infrastructure session, configured to maintain continuous biometric verification and Capacity Token renewal for the duration of a browser session without requiring operating system-level installation privileges, and to enforce a zero-footprint state upon browser session termination by purging all locally cached biometric data and session-specific cryptographic material.

10. The method of claim 1, wherein the browser-executable sandbox module is a persistent containerized agent deployed within an enterprise browser environment or virtual desktop infrastructure session, the persistent containerized agent configured to: maintain continuous biometric verification of the authenticated user for the duration of the browser session by continuously capturing facial biometric vectors via camera hardware access governed by enterprise-administered browser policy, comparing the captured vectors against enrolled descriptor vectors for the claimed user identifier in the sovereign biometric identity database, and issuing and renewing Capacity Tokens bound to the active Identity and Access Management session without requiring operating system-level installation privileges and without requiring per-session user approval for camera access;
communicate with the sovereign central server using a unique agent registration credential assigned at deployment time and session-specific rotating cryptographic keys, wherein the sovereign central server validates both the agent registration credential and the current key rotation state for each submission and rejects submissions from unregistered agents or agents with invalid key rotation states;
respond to an administrative helpdesk verification trigger received from the sovereign central server by one of: transmitting a real-time verification confirmation to the requesting support agent based on the current biometric verification state if that state is within a configurable confidence window; or executing an on-demand biometric capture via the enterprise-configured camera access, extracting facial biometric vectors from the captured image, comparing the extracted vectors against enrolled descriptor vectors for the claimed user identifier in the sovereign biometric identity database, and transmitting the comparison result to the requesting support agent; and
enforce a zero-footprint state upon browser session termination by purging all locally cached biometric data, enrolled descriptor vectors, session-specific cryptographic material, and Capacity Token state from browser memory without writing any biometric data to persistent storage.

11. A method for enterprise-scale continuous biometric authentication governing physical and remote connections on a managed computer device, the method comprising:
authenticating incoming physical and remote connections to the managed device by tying real-time facial descriptors to a userID established via an Identity and Access Management system;
consolidating the real-time facial descriptors and relating them to the userID within a central management server sovereign to an enterprise, without utilizing k-means clustering of organizational behavior;
establishing a continuous trust session on the managed device utilizing a deterministic neural network to verify a human presence against a known baseline;
governing outbound network connections originating from the managed device to a non-managed device by dynamically binding said outbound network connections to a session-specific cryptographic token; and
upon a failure of the continuous trust session, revoking the session-specific cryptographic token to sever the outbound network connection, and
executing a localized session restriction on the managed device consisting exclusively of rendering an application-layer graphical obfuscation overlay that captures all user interface focus, thereby automatically suppressing keyboard and mouse hardware input events to prevent data entry, without adjusting operating system hardware power configurations.

12. The method of claim 11, further comprising instantiating a video proxy service on the managed device to create a virtual duplicate of a hardware video input process, thereby resolving hardware resource contention by multi-streaming video content from a single hardware source to both a continuous biometric security analytics module and a third-party communication application simultaneously.

13. The method of claim 11, further comprising enforcing a topology-agnostic multi-party authorization logic for a restricted transaction, comprising executing at least one of:
a sequential mode enforcing a chain of custody by validating a primary user, storing a pending transaction state, and unlocking a subsequent validation step for at least one distinct secondary user; or
a simultaneous mode enforcing multi-party consensus by awaiting valid biometric signals from a plurality of distinct users within a configurable time window, wherein said biometric signals are synchronized by the central management server across distributed geographic endpoints.

14. The method of claim 11, further comprising executing in-band verification during a remote collaboration interaction, including a telehealth consultation, a remote human resources interview, or a government service workflow, comprising:
accessing a video stream of a remote participant in the collaboration interaction through one of an intermediary network gateway,
a corporate virtual asset hosting the collaboration session, or a collaboration application executing on a device participating in the session; and
analyzing the accessed video stream to perform biometric identity verification of the remote participant, thereby identifying the human presence from the existing collaboration feed without requiring a pre-registered trusted authentication device on the remote participant's side.

15. The method of claim 11, wherein the known baseline is established by one of: (a) ingesting a static, two-dimensional out-of-band headshot from an authoritative external source and executing an organic learning calibration during an initial live login by merging the static two-dimensional out-of-band headshot with live environmental data, without generating a three-dimensional facial rendering; or (b) capturing live biometric data at the user's first successful authenticated login to the managed device and associating the extracted facial descriptor vectors with the authenticated user identifier, without requiring a pre-existing headshot.

16. The method of claim 11, further comprising performing User-Behavior Analytics to identify a historical baseline, wherein the historical baseline is derived exclusively from each individual user's own access history recorded during prior established continuous trust sessions having a verified human presence, and wherein anomalous deviation from the individual historical baseline generates a risk signal that is provided as a direct input to the adaptive device response configuration and is available for export to an external Security Information and Event Management platform.

17. The method of claim 11, further comprising extending the continuous trust session to service-to-service single sign-on token exchanges by operating as a continuous presence attestation oracle, comprising
receiving a presence validation polling request from an external Identity Provider and transmitting a real-time binary presence attestation state to the external Identity Provider based on the continuous trust session, without embedding authentication objects into network packet headers.

18. The method of claim 11, further comprising executing an asynchronous, non-blocking multi-party forensic authorization protocol comprising:
utilizing a forensic capture agent to asynchronously record a pre-event screen state,
continuously validate at least one secondary user during a transaction window in parallel to a primary business application, and
assemble the pre-event screen state, environmental still captures, biometric verification results, and transaction metadata into an evidentiary record; transmit the evidentiary record to the sovereign central server; and apply a client-unique cryptographic signing key held exclusively by the sovereign central server to produce a signed cryptographically hashed evidentiary package for non-repudiation, wherein the client-unique signing key is inaccessible to the endpoint agent and to the user whose actions are recorded.

19. The method of claim 11, further comprising executing an on-demand helpdesk verification workflow during a live support interaction, comprising:
receiving an administrative trigger from a remote support agent requesting human verification of a user;
querying, by the central management server, the continuous trust session on the managed device; and
transmitting a real-time verification confirmation to the remote support agent based strictly on an active state of the continuous trust session, expressly without prompting the user for an active authentication input and without interrupting a workflow of the user on the managed device.

20. The method of claim 11, further comprising detecting absence of the authenticated user from the physical keyboard of the managed device during an active session, and upon detecting said absence, revoking the session-specific cryptographic token to sever outbound network connections originating from the managed device, wherein the absence detection applies equally to locally connected physical sessions and to remotely tunneled sessions accessing the managed device.

21. The method of claim 11, further comprising monitoring hardware authentication devices connected to the managed device, and upon detecting that a hardware authentication device remains connected to the managed device in the absence of confirmed continuous biometric presence of the associated user identifier, generating a security alert and applying a configured risk policy to the active session.

22. The method of claim 11, further comprising enforcing continuous biometric presence verification during an active remote access session by delivering a biometric verification challenge to the originating client device through one of: (a) a verification challenge tunneled through the active session channel to the originating client device; or (b) an out-of-band secure redirect request delivered to the originating client device, and revoking the session-specific cryptographic token upon failure to confirm biometric presence within a configurable response window.

23. The method of claim 11, further comprising dynamically adjusting a weighting of individual biometric descriptors based on a current environmental state captured by the continuous biometric security analytics module, classifying the current environment as known, modified, or novel relative to a stored environmental baseline, assigning an elevated risk classification to modified and novel environments, and automatically adjusting device response configurations according to client-configurable policy mappings based on the environmental risk classification.

24. The method of claim 11, wherein upon unavailability of the sovereign central server, the system suspends Capacity Token issuance and defers to the authentication state managed by the enterprise Identity Provider for the duration of the unavailability, and resumes biometric verification and Capacity Token issuance upon sovereign server restoration.

25. A method for continuous biometric authentication utilizing a sovereign identity database, comprising:
extracting an encrypted flat facial image of a user at a local edge device without transmitting a continuous raw video stream;
transmitting the encrypted flat facial image to a sovereign server;
executing an in-memory verification process wherein the sovereign server decrypts the image, extracts biometric vectors, and compares the vectors against a sovereign database strictly within volatile memory (RAM);
generating an algorithmic baseline and a validation token upon a successful match;
transmitting the algorithmic baseline to the local edge device for subsequent continuous biometric tracking; and
purging the encrypted flat facial image and extracted vectors from the volatile memory of the sovereign server, without writing said image or vectors to persistent storage.

26. The method of claim 25, wherein extracting the encrypted flat facial image is performed by an On-Demand Ephemeral Executable executing within a web browser sandbox on an unmanaged local edge device.

27. A method for detecting unauthorized access through dual-domain presence corroboration, the method comprising:
receiving a first physical access control event from a physical access control entry point, the first event comprising at least one of a biometric verification or an access credential authentication resolving to a first user identifier and a first timestamp;
receiving a second biometric verification event from a managed computing endpoint, the second event comprising a facial biometric match against a sovereign biometric identity database resolving to a second user identifier and a second timestamp;
determining whether the first user identifier and the second user identifier correspond to the same enrolled user record in the sovereign biometric identity database;
determining whether a temporal relationship between the first timestamp and the second timestamp satisfies a configurable corroboration window;
classifying the second biometric verification event as a corroborated session if both determinations are satisfied, and as a Corroboration Anomaly if either determination is not satisfied; and
applying a risk policy to the Corroboration Anomaly comprising at least one of: elevated authentication challenge, Capacity Token withholding, session restriction, or security alert transmission to an external security information and event management system.

28. The method of claim 27, wherein classifying the second biometric verification event as a Corroboration Anomaly comprises determining that no corroborating physical entry event exists within the configurable corroboration window for the user identifier associated with the digital session, and wherein the applied risk policy comprises at minimum generating a security alert indicating a potential unauthorized remote session.

29. The method of claim 27, further comprising receiving a physical exit event for a user identifier that has an active digital session, classifying the condition as a Corroboration Anomaly, and applying a risk policy comprising at minimum initiating revocation of the session-specific cryptographic token associated with the active digital session.
